(19) United States
(12) Patent Application Publication
(10) Pub. No.: US 2025/0380692 A1
(43) Pub. Date: Dec. 18, 2025

(54) NUTRIENT AND/OR ANTIMICROBIAL SOLUTIONS

(71) Applicant: Terra Vera Corporation, Placitas, NM (US)

(72) Inventors: Justin Sanchez, Placitas, NM (US); Arnold J. Howard, Placitas, NM (US)

(21) Appl. No.: 18/877,841

(22) PCT Filed: Jun. 26, 2023
(86) PCT No.: PCT/US2023/026252

§ 371 Date: Dec. 20, 2024

Related U.S. Application Data
(60) Provisional application No. 63/355,939, filed on Jun. 27, 2022.

(51) Int. Cl. A01N 33/04; C25B 3/09

(52) U.S. Cl. CPC A01N 33/04; C25B 3/09

(57) ABSTRACT

Methods and apparatuses for the simultaneous production of alternatively powdery mildew and molds (PM) treatment or prevention chemicals on plants, providing nutrients for plants, boosting flavor and chemical profiles in plants and/or remediation and prevention of insect infestation in plants and animals using an integrated electrolytic cell system.

### RELATED APPLICATION

This application claims priority to U.S. Provisional Patent Application No. 63/355,939, titled NUTRIENT AND ANTIMICROBIAL SOLUTIONS, filed on Jun. 27, 2022, the contents of which are hereby incorporated by reference.

### BACKGROUND OF THE DISCLOSURE

Various compositions can be used to provide nutrients to plants. However, some compositions are limited in terms of the benefits they can provide. It is therefore desirable to continue to develop compositions that can help to enhance plant growth.

### SUMMARY OF THE DISCLOSURE

Objects, advantages and novel features, and further scope of applicability of the present disclosure will be set forth in part in the detailed description to follow, taken in conjunction with the accompanying drawings, and in part will become apparent to those skilled in the art upon examination of the following, or may be learned by practice of the disclosure. The objects and advantages of the disclosure may be realized and attained by means of the instrumentalities and combinations particularly pointed out in the appended claims.

### BRIEF DESCRIPTION OF THE DRAWING

The accompanying drawing, this is incorporated into and form a part of the specification, illustrate several aspects of the present disclosure and, together with the description, serve to explain the principles of the disclosure. The drawing is only for the purpose of illustrating a preferred aspect of the disclosure and are not to be construed as limiting the disclosure.

FIG. 1. is a schematic drawing of an electrochemical system designed to produce a chemical that treats & prevents microbes, such as viruses, bacteria, yeasts, molds, and/or fungi as well as some insects, while providing nutrients to plants.

### DETAILED DESCRIPTION OF ASPECTS OF THE DISCLOSURE

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting, information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The present disclosure is related to the use of electrolytics and/or complex blends of chemicals to derive organic amine chemistries which have simultaneous use as nutrients for plants and/or for remediating and preventing powdery mildew, molds, and/or insect infestation on a wide variety of plants, animals, and/or agricultural products.

Providing nutrients for plant growth from seed to harvest phases is a common challenge in modern agriculture. As well, controlling both the outbreak of Powdery Mildew and Molds (PM) in plants and controlling the outbreak of insect infestation in such plants without damaging the plants are several complex and common problems in agriculture. Powdery Mildew and Mold presence in plants makes them unsellable such that there is a huge industry associated with its remediation by such means as Ozone treatments, Radiation, and chemical sprays or fogging of plants in either an indoor or outdoor farm. Additionally, feeding nutrients either foliarly or through plant roots during all stages of plant growth from seed to final harvest are broad technological challenges in agriculture. Finally, controlling the infestation of insects in agriculture and farming has its own unique challenges. Some approaches pertain to PM remediation and prevention. There are additional approaches in agriculture for nutrient supplementation and uptake. As well, several approaches such as sprayed or fogged pesticides and topical application of beneficial insects are used to prevent and remediate insect infestation such as aphids, mites or flies in agricultural plants and farm animals.

In view of the current approaches, it would therefore be unexpected to one skilled in the art that a system & conditions could be conceived of where one combines in one unique system and set of use conditions chemistries that can serve multiple purposes, such as providing activated chemicals used for PM remediation & prevention, providing plant nutrition and remediation & prevention of insects. Such a system & associated use conditions can be advantageous in the broad fields of agriculture and farming as an economic advantage.

Aspects of the present disclosure, as well as the practice of the present disclosure, are intended to utilize electrolysis processes to directedly cause the creation of an activated organic amine & salt solution at subsaturated concentrations, typically at salt concentrations between 5 g/L and 70 g/L but usually around 15-30 g/L and Total Halogen concentrations between 3.5 g/L and 6 g/L but usually around 5 g/L As described, these organic amine containing chemistries have simultaneous unique and combined benefits.

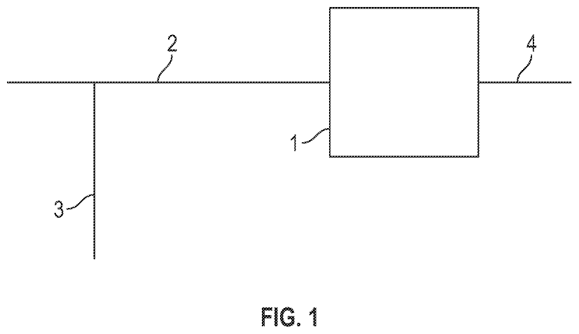

In an aspect of the present disclosure, shown, for example, in FIG. 1, box 1 represents the electrolytic cell (including at least one electrode) where the chemical reactions occur Line 2 transfers an aqueous solution to be electrolyzed from a source reservoir not shown here which can contain two or more organic amines. Typically these organic amines are individual amino acids, combinations of several amino acids, alternative sources of halogens, EPA (Environmental Protection Agency, a US Government Agency) “25B List” additives, and/or beneficial enhancers to boost chemical profiles in plants, and/or commonly occurring salts (Sodium Chloride, Potassium Chloride, Potassium Dichromate, Calcium Chloride, Sodium Bisulfate, Copper Sulfate, Magnesium Sulphate, Calcium Carbonate, Sodium Nitrate, Aluminum Sulphate, etc.) in dissolution. Examples of suitable amino acids include L-Glutamic Acid, L-Leucine, L-Isoleucine, L-Valine, L-Glutamine, L-Lysine HCL, L-Methionine, L-Phenylalanine, L-Threonine, L-Tryptophan, L-Histidine HCL, L-Proline, L-Tyrosine, Beta-Alanine, L-Arginine Base, Taurine, Glycine, L-Citrulline, Aspartic acid, Serine, Proline, Alanine, Cystine, or a mixture thereof. Examples of halide salts includes salts of fluorine, chlorine, bromine, iodine, astatine, tennessine, or a mixture thereof. Other organic amines can include ALCAR HCL (acetyl L-carnitine). Examples of EPA 25B compliant component comprises the following compounds with CAS numbers provided in parentheticals, where available, castor oil (8001-79-4), cedarwood oil (85085-29-6, 68990-83-0, 8000-27-9), cinnamon, cinnamon oil (8015-91-6), 2-hydroxypropane-1,2,3-tricarboxylic acid (77-92-9), citronella, citronella oil (8000-29-1), clove, clove oil (8000-34-8), corn gluten meal (66-071-96-3), corn oil (8001-30-7), commint, cornmint oil (68917-18-0), cottonseed oil (8001-29-4), dried blood (68911-49-9), 4-allyl-2-methoxyphenol (97-53-0), garlic, garlic oil (8000-78-0), (2e)-3,7, dimethyloctoa-2,6-dien-1-ol (106-24-1), geranium oil (8000-46-2), lauryl sulfate (151-41-7), lemongrass oil (8007-02-1), linseed oil (8001-26-1), 2-hydroxybutanedioic acid (6915-15-7), peppermint, peppermint oil (8006-90-4), 2-phenylethy propionate (122-70-3), potassium (2E,4E)-hexa-2,4-dienoate (24634-61-5), putrescent whole egg solid (51609-52-0), rosemary, rosemary oil (8000-25-7), sesame, sesame oil (8008-74-0), sodium chloride (7647-14-5), sulfuric acid monododecyl ester, sodium salt (151-21-3), soybean oil (8001-22-7), spearmint, spearmint oil (8008-79-5), thyme, thyme oil (8007-46-3), zinc (7440-66-6), or a mixture thereof. The additive can include CarboLoad, available from Advanced Nutrients, West Hollywood, CA; Sweet, available from Botanicare, Vancouver, WA; a food grade black strap molasses; Winterfrost, available from New Millennium Nutrients, Fort Morgan CO; a terpene solution, available from True Terpenes, Portland, OR; Terpinator, available from Rhizoflora, Bud Taste and Terpene Enhancer, available from Advanced Nutrients, West Hollywood, CA; Signal, available from TPS Nutrients, Bellevue WA, Ludicrous Terpenes Turbo, available from Ludicrous Nutrients, Scottsdale, AZ.

In some aspects, the composition of the organic amine component and salt (including an optional additive) can be a precursor solution that is later activated or electrolyzed. In some aspects especially in cases where the composition includes the organic amine component and a EPA 25B compliant component, the composition can be useful as a nutritional and/or antibacterial composition without needing to be activated or electrolyzed.

In the practice of the present disclosure, the solution transferred along line 2 contains at least halogen ions. Line 3 is used to transfer deionized, distilled water, for example, from a reverse osmosis system not shown here. Accordingly, the solution in line 3 mixes in with the solution in line 2 and is pumped into the electrolytic cell box 1. Electrolytic cell 1 is controlled by a control system not shown here. A plurality of sensors, similarly, not shown explicitly in FIG. 1, are used to provide telemetry to the control system so that the overall electrolytic process can be automatically controlled Sensors useful in this process will be obvious to one skilled in the art and include sensors designed to measure factors such as, but not limited to, temperature, conductivity, pH, flow rate, cell voltage, or cell current. The combined solution is then introduced into electrolytic cell 1 where a voltage is applied to the combined solution, which is then transferred along line 4 to a reservoir not shown here. The voltage can be in a range of about 4V to about 10V or about 5V to about 7V.

It has been observed that these unique combinations of chemicals when electrolyzed result in organic amine-based chemistries with increased stability, higher total chlorine, or total halogen concentrations. They also work with alternative sources of halogens which differentiates this work from prior art as protonated or acidified organic amines. They also make unique combinations of these chemicals into chemicals that are more compliant with broader EPA regulations like 25B. Without intending to be limited to any theory, it is suspected that when the method according to the disclosure is conducted, the chemistry is changed to increase total halogen concentrations and drive towards the creation of more stable monohalomines when compared to dihalomines as reactionary products. It is also theorized that these non-standard combinations of chemicals when electrolyzed serve as enhancers to boost flavor profiles or chemical profiles in various agricultural plants. Finally, as stated, these combinations of chemicals when electrolyzed also are effective to prevent or remediate insect or pest infestation in plants, and animals. This completes the full individual and combined benefits of this art for use as PM treatment or prevention, plant nutritional additives, EPA 25B complaint chemicals, insect remediation or prevention chemicals or finally as flavor enhancers or performance boosters for plants.

More specifically, electrolyzed blends of two or more organic amines combined with halide salts have shown dramatically higher (roughly 1.5-2X) higher Total Halogen measurements, as well as longer overall stability of the oxidant (1.5-2X), making the output of these much more useful and economical for agricultural or farming applications. These relative values can be compared to the solutions found in United States Published Patent Application No. 2019/0345620.

Electrolyzed blends of two or more organic amines with salts such as potassium monophosphate and halide salts still show dramatically higher Total Halogen and stability, but the relative ratios of the selected organic amines with the halide salt and a phosphate source (e.g, potassium monophosphate) enable tuning the final chemistry to be applied to specific “N-P-K” ratios that are appropriate for a plant's specific nutrient needs.

Addition of minimal risk pesticides (such as those listed on the EPA 25B list) with the blend of two or more organic amines, a phosphate source, do not require electrolysis, making them effective anti-microbials or anti-fungals without needing to electrolyze the entire blend. These blends can be electrolyzed, however, making them potentially more effective against microbes and pests.

One aspect of the current disclosure is electrolysis of two or more organic amines, with one of them one of which the halide is provided by a protonated amino acid (e.g., L-Lysine HCl). This can be superior for many applications, including tuning the “N—P-K” ratio of a blend where the cation from the salt is not desirable.

Another aspect of the current disclosure is electrolysis of two or more amino acids, with one of them protonated but also containing a phosphate source and/or a halide salt, the relative ratios of which are tuned to provide a chemistry at the final proper “N—P-K” ratio.

The solution described herein can be applied as spray (e.g., folier spray) or a fog when applied directly to plants (or parts of plants) that are exposed above the ground. It is also possible to apply the solution to plant roots (e.g., hydroponically).

### EXAMPLES

### Procedures

### Experimental Procedure for Performing Electrolysis of Amino Acids and Salt Solutions

Food-grade precursors in all cases for these experiments that are commercially available. A commercially available electrolytic reactor as is shown in FIG. 1 comprising of two inlet source lines consisting of an inlet water line (reverse osmosis, RO water was employed) and a brine line (which contained typically a mixture of salts and amino acids) was used. For all experiments conducted herein, a 0.5 Liter solution of brine was prepared where the RO water was measured using a graduated cylinder. The dry powder precursor salts and amino acids or other solid powders were measured out using a commercially available digital balance with readings down to 0.0000 grams of accuracy. After the brine solution precursor powders were weighed, they were mixed in a one-liter plastic container with the RO water and stirred sufficiently such that in most cases the powder was not visible in the mixture as it was fully soluble. Then the reactor inlet lines were inserted into the brine solution container and connected to the RO water supply. The outlet blend line was placed into an exit plastic container five-gallon bucket and the reactor was powered on. Following the reactor's operating manual, once the reactor cell current was stable at 10.0 Amps, the outlet blend line was transferred from the five-gallon bucket to an empty, clean one liter plastic container. Once the one-liter plastic container was approximately three fourths full, the reactor was turned off and our blend solution was fully prepared and experimental observations could begin. In some cases, only the brine solution containing a salt precursor was electrolyzed (without Amino Acids or other additives). This exit solution was used in subsequent experiments wherein dry powder mixtures were added to the exit solution and fully mixed after electrolysis and this solution was only used for the same day and then discarded to ensure repeatability of measurements.

### Experimental Procedure for Measuring Free Available Chlorine (FAC) and Total Chlorine (TC) in Solution

After the exit blends were produced from the electrolytic reactor and collected in one-liter clean plastic containers they were capped and labelled with experimental information including the production date and time. FAC and TC of the experimental organic amine solutions were measured in the following way. First a 250 ml volumetric flask was accurately filled with room temperature RO water. A commercially available pipette was then used to measure out 100 microliters of exit blend and injected into the volumetric flask. The dilute mixture in the flask was capped with a clean cap and shaken vigorously several times to ensure complete mixing. In support of these measurements a commercially available spectrophotometer was used from the HACH company, model DR 900 Multiparameter Colorimeter. The spectrophotometer comes with two glass cells, and one was labelled on the top “FAC” and the other “TC” to dedicate them to their respective measurement types due to the sensitivity of the measurements. First the FAC cell was filled to the visible white line on the side of the cell. The spectrophotometer was then set up in the FAC mode and a measurement was taken of FAC. Next the same 250 ml flask was used again to fill the “TC” glass cell. The spectrophotometer was then set up in the TC mode and a measurement was taken of TC. This procedure of taking a pipette sample of the exit blend, mixing it in the 250 ml volumetric flask and then taking FAC and TC measurements was repeated two more times after fully rinsing the flask, pipette and glass cells in RO water and then air dried. In some experiments these measurements were taken on subsequent days to record the stability of the TC and FAC measurements over time. Due to the dilution performed the readouts of the spectrophotometer were multiplied by 2500 to yield FAC & TC concentrations in mg/L and these numbers were recorded.

As used herein Amino Acid #1, Amino Acid #2, Amino Acid #3, and Amino Acid #4 are independently selected from the group of L-Glutamic Acid, L-Leucine, L-Isoleucine, L-Valine, L-Glutamine, L-Lysine HCL, L-Methionine, L-Phenylalanine, L-Threonine, L-Tryptophan, L-Histidine HCL, L-Proline, L-Tyrosine, Beta-Alanine, L-Arginine Base, Taurine, Glycine, L-Citrulline, Aspartic acid, Serine, Proline, Alanine, Cystine, Betaine-HCL.

### Results

Tables 1-4 show the effect of using one or more amino acids on the FAC and TC in an electrolyzed solution.

TABLE 1

| Amino Acid #1 | FAC Content in | TC Content in |
|---|---|---|
| Content | Electrolyzed Solution | Electrolyzed Solution |
| (g/L) | (mg/L) | (mg/L) |
| 60 | 1300-1700 | 2475-2825 |
| 80 | 1050-1350 | 2575-2850 |
| 100 | 600-825 | 2600-2800 |
| 120 | 0-125 | 2400-2650 |
| 140 | 0-100 | 2375-2675 |
| 160 | 0 | 2450-2725 |
| 180 | 0 | 2275-2450 |

TABLE 2

| | | FAC Content in | TC Content in |
|---|---|---|---|
| Amino Acid | Amino Acid | Electrolyzed | Electrolyzed |
| #1 Content | #2 Content | Solution | Solution |
| (g/L) | (g/L) | (mg/L) | (mg/L) |
| 60 | 65 | 2750-3200 | 5075-5325 |
| 80 | 90 | 1900-1450 | 5150-5425 |
| 100 | 110 | 850-1250 | 5025-5275 |
| 120 | 130 | 50-150 | 4950-5175 |
| 140 | 160 | 0-75 | 5225-5400 |
| 160 | 180 | 0 | 4875-5350 |
| 180 | 200 | 0 | 5150-5375 |

TABLE 3

| | | FAC Content in | TC Content ir |
|---|---|---|---|
| Amino Acid | Amino Acid | Electrolyzed | Electrolyzed |
| #1 Content | #3 Content | Solution | Solution |
| (g/L) | (g/L) | (mg/L) | (mg/L) |
| 60 | 70 | 2700-3250 | 5050-5300 |
| 80 | 95 | 1800-1550 | 5050-5325 |
| 100 | 120 | 800-1275 | 5000-5300 |
| 120 | 145 | 0-175 | 4900-5255 |
| 140 | 170 | 0-100 | 5125-5450 |
| 160 | 190 | 0 | 5050-5300 |
| 180 | 215 | 0 | 5100-5250 |

TABLE 4

| | | FAC Content in | TC Content in |
|---|---|---|---|
| Amino Acid | Amino Acid | Electrolyzed | Electrolyzed |
| #1 Content | #4 Content | Solution | Solution |
| (g/L) | (g/L) | (mg/L) | (mg/L) |
| 60 | 65 | 2750-3300 | 5075-5350 |
| 80 | 90 | 1800-1450 | 5000-5425 |
| 100 | 110 | 800-1450 | 5025-5325 |
| 120 | 130 | 0-150 | 4800-5175 |
| 140 | 160 | 0-100 | 5225-5300 |
| 160 | 180 | 0 | 4900-5350 |
| 180 | 200 | 0 | 5150-5350 |

Tables 5-7 show the effect of adding a phosphorous source to an amino acid solution and the resulting FAC and TO content in an electrolyzed solution.

TABLE 5

| Amino | Amino | | FAC Content in | TC Content in |
|---|---|---|---|---|
| Acid #1 | Acid #2 | Phosphorus | Electrolyzed | Electrolyzed |
| Content | Content | Source | Solution | Solution |
| (g/L) | (g/L) | (g/L) | (mg/L) | (mg/L) |
| 100 | 90 | 25 | 2750-3300 | 5075-5350 |
| 120 | 110 | 30 | 1800-1450 | 5000-5425 |
| 140 | 125 | 56 | 800-1450 | 5025-5325 |
| 160 | 145 | 50 | 0-150 | 4800-5175 |
| 180 | 160 | 55 | 0-100 | 5225-5300 |
| 200 | 180 | 65 | 0 | 4900-5350 |
| 220 | 200 | 70 | 0 | 5150-5350 |

NPK Ratio:Nitrogen: 11.1%;
Phosphorus: 3.9%;
Potassium: 4.9%

TABLE 6

| | | FAC Content in | TC Content in |
|---|---|---|---|
| Amino Acid | Phosphorus | Electrolyzed | Electrolyzed |
| #1 Content | Source | Solution | Solution |
| (g/L) | (g/L) | (mg/L) | (mg/L) |
| 90 | 35 | 2700-3250 | 5050-5300 |
| 110 | 45 | 1800-1550 | 5050-5325 |
| 130 | 50 | 800-1275 | 5000-5300 |
| 150 | 60 | 0-175 | 4900-5255 |
| 170 | 70 | 0-100 | 5125-5450 |
| 190 | 75 | 0 | 5050-5300 |
| 210 | 85 | 0 | 5100-5250 |

NPK Ratio:Nitrogen: 6.1%;
Phosphorus: 10.3%;
Potassium: 13.1%

TABLE 7

| Amino Acid #1 | FAC Content in | TC Content in |
|---|---|---|
| Content | Electrolyzed Solution | Electrolyzed Solution |
| (g/L) | (mg/L) | (mg/L) |
| 125 | 2750-3300 | 5075-5350 |
| 145 | 1800-1450 | 5000-5425 |
| 165 | 800-1450 | 5025-5325 |
| 185 | 0-150 | 4800-5175 |
| 205 | 0-100 | 5225-5300 |
| 225 | 0 | 4900-5350 |
| 245 | 0 | 5150-5350 |

NPK Ratio:Nitrogen: 11.2%;
Phosphorus: 0.0%;
Potassium: 0.0%

Table 8 shows that a protonated amino acid can be mixed with another amino acid and the electrolyzed solution can have acceptable FAC and TC content, while being substantially non-odorous

TABLE 8

| Amino | | FAC Content in | TC Content in |
|---|---|---|---|
| Acid #1 | Protonated Amino | Electrolyzed | Electrolyzed |
| Content | Acid with Halogen | Solution | Solution |
| (g/L) | (g/L) | (mg/L) | (mg/L) |
| 60 | 300 | 2750-3300 | 5075-5350 |
| 80 | 450 | 1800-1450 | 5000-5425 |
| 100 | 550 | 800-1450 | 5025-5325 |
| 120 | 700 | 0-150 | 4800-5175 |
| 140 | 800 | 0-100 | 5225-5300 |
| 160 | 900 | 0 | 4900-5350 |
| 180 | 1000 | 0 | 5150-5350 |

Tables 9-11 demonstrate that electrolyzed solutions of various amino acid combinations can produce acceptable FAC and TC content as well as different NPK ratios.

TABLE 9

| Amino | Amino | | FAC Content in | TC Content in |
|---|---|---|---|---|
| Acid #1 | Acid #2 | Phosphorus | Electrolyzed | Electrolyzed |
| Content | Content | Source | Solution | Solution |
| (g/L) | (g/L) | (g/L) | (mg/L) | (mg/L) |
| 60 | 55 | 25 | 2750-3300 | 5075-5350 |
| 80 | 70 | 30 | 1800-1450 | 5000-5425 |
| 100 | 90 | 40 | 800-1450 | 5025-5325 |
| 120 | 110 | 50 | 0-150 | 4800-5175 |
| 140 | 125 | 55 | 0-100 | 5225-5300 |
| 160 | 145 | 65 | 0 | 4900-5350 |
| 180 | 160 | 70 | 0 | 5150-5350 |

NPK Ratio:Nitrogen: 11.1%;
Phosphorus: 3.9%;
Potassium: 4.9%

TABLE 10

| | | FAC Content in | TC Content in |
|---|---|---|---|
| Amino Acid | Phosphorus | Electrolyzed | Electrolyzed |
| #1 Content | Source | Solution | Solution |
| (g/L) | (g/L) | (mg/L) | (mg/L) |
| 60 | 25 | 2700-3250 | 5050-5300 |
| 80 | 30 | 1800-1550 | 5050-5325 |
| 100 | 40 | 800-1275 | 5000-5300 |
| 120 | 50 | 0-175 | 4900-5255 |
| 140 | 55 | 0-100 | 5125-5450 |
| 160 | 65 | 0 | 5050-5300 |
| 180 | 70 | 0 | 5100-5250 |

NPK Ratio:Nitrogen: 6.1%;
Phosphorus: 10.3%;
Potassium: 13.1%

TABLE 11

| | | | Protonated | FAC | TC |
|---|---|---|---|---|---|
| Amino | Amino | Phos- | Amino Acid | Content in | Content in |
| Acid #1 | Acid #2 | phorus | with | Electrolyzed | Electrolyzed |
| Content | Content | Source | Halogen | Solution | Solution |
| (g/L) | (g/L) | (g/L) | (g/L) | (mg/L) | (mg/L) |
| 60 | 85 | 30 | 60 | 275-300 | 550-650 |
| 80 | 110 | 45 | 90 | 180-225 | 500-625 |
| 100 | 140 | 55 | 110 | 75-150 | 525-535 |
| 120 | 170 | 65 | 130 | 0-100 | 450-575 |
| 140 | 200 | 80 | 160 | 0-50 | 525-650 |
| 160 | 225 | 90 | 180 | 0 | 500-550 |
| 180 | 250 | 100 | 200 | 0 | 450-550 |

NPK Ratio:Nitrogen: 10.2%;
Phosphorus: 2.2%;
Potassium: 18.1%

### EXEMPLARY ASPECTS

The following exemplary aspects are provided, the numbering of which is not to be construed as designating levels of importance:

Aspect 1 provides a plant nutrient and/or antimicrobial precursor solution comprising:
an organic amine component comprising two or more organic amines; and
a salt component.

Aspect 2 provides the precursor solution of Aspect 1, wherein the two or more organic amines comprises two amino acids.

Aspect 3 provides the precursor solution of any one of Aspects 1 or 2, wherein the organic amine component comprises L-Glutamic Acid, L-Leucine, L-Isoleucine, L-Valine, L-Glutamine, L-Lysine HCL, L-Methionine, L-Phenylalanine, L-Threonine, L-Tryptophan, L-Histidine HCL, L-Proline, L-Tyrosine, Beta-Alanine, L-Arginine Base, Taurine, Glycine, L-Citrulline, Aspartic acid, Serine, Proline, Alanine, Cystine, Betaine-HCL or a mixture thereof.

Aspect 4 provides the precursor solution of any one of Aspects 1-3, wherein the salt component comprises a halide salt.

Aspect 5 provides the precursor solution of Aspect 4, wherein the halide salt comprises fluorine, chlorine, bromine, iodine, astatine, tennessine, or a mixture thereof.

Aspect 6 provides the precursor solution of any one of Aspects 1-5, wherein the salt component comprises a phosphate salt.

Aspect 7 provides the precursor solution of any one of Aspects 1-6, wherein the salt component comprises a mixture of a halide salt and a phosphate salt.

Aspect 8 provides the precursor solution of any one of Aspects 1-7, further comprising an additive.

Aspect 9 provides the precursor solution of Aspect 8, wherein the additive comprises a nutritional additive, pesticide, an insect remediation chemical, or a mixture thereof.

Aspect 10 provides the precursor solution of any one of Aspects 8 or 9, wherein the additive is an EPA 25B compliant chemical.

Aspect 11 provides the precursor solution of Aspect 10, wherein the EPA 25B compliant chemical comprises castor oil (8001-79-4), cedarwood oil (85085-29-6, 68990-83-0, 8000-27-9), cinnamon, cinnamon oil (8015-91-6), 2-hydroxypropane-1,2,3-tricarboxylic acid (77-92-9), citronella, citronella oil (8000-29-1), clove, clove oil (8000-34-8), corn gluten meal (66-071-96-3), corn oil (8001-30-7), cornmint, commint oil (68917-18-0), cottonseed oil (8001-29-4), dried blood (68911-49-9), 4-allyl-2-methoxyphenol (97-53-0), garlic, garlic oil (8000-78-0), (2c)-3,7,dimethyloctoa-2,6-dien-1-ol (106-24-1), geranium oil (8000-46-2), lauryl sulfate (151-41-7), lemongrass oil (8007-02-1), linseed oil (8001-26-1), 2-hydroxybutanedioic acid (6915-15-7), peppermint, peppermint oil (8006-90-4), 2-phenylethy propionate (122-70-3), potassium (2E,4E)-hexa-2,4-dienoate (24634-61-5), putrescent whole egg solid (51609-52-0), rosemary, rosemary oil (8000-25-7), sesame, sesame oil (8008-74-0), sodium chloride (7647-14-5), sulfuric acid monododecyl ester, sodium salt (151-21-3), soybean oil (8001-22-7), spearmint, spearmint oil (8008-79-5), thyme, thyme oil (8007-46-3), zinc (7440-66-6), or a mixture thereof.

Aspect 12 provides a plant nutrient and/or antimicrobial precursor solution comprising:
an organic amine component comprising two or more amino acids;
a salt component; and
an additive component.

Aspect 13 provides the precursor solution of Aspect 12, wherein the organic amine component comprises two amino acids.

Aspect 14 provides the precursor solution of any one of Aspects 12 or 13, wherein the organic amine component comprises L-Glutamic Acid, L-Leucine, L-Isoleucine, L-Valine, L-Glutamine, L-Lysine HCL, L-Methionine, L-Phenylalanine, L-Threonine, L-Tryptophan, L-Histidine HCL, L-Proline, L-Tyrosine, Beta-Alanine, L-Arginine Base, Taurine, Glycine, L-Citrulline, Aspartic acid, Serine, Proline, Alanine, Cystine, Betaine-HCL or a mixture thereof.

Aspect 15 provides the precursor solution of any one of Aspects 12-14, wherein the salt component comprises a halide salt.

Aspect 16 provides the precursor solution of Aspect 15, wherein the halide salt comprises fluorine, chlorine, bromine, iodine, astatine, tennessine, or a mixture thereof.

Aspect 17 provides the precursor solution of any one of Aspects 12-16, wherein the salt component comprises a phosphate salt.

Aspect 18 provides the precursor solution of any one of Aspects 12-17, wherein the salt component comprises a mixture of a halide salt and a phosphate salt.

Aspect 19 provides the precursor solution of any one of Aspects 12-18, wherein the additive comprises a nutritional additive, pesticide, an insect remediation chemical, or a mixture thereof.

Aspect 20 provides the precursor solution of Aspect 19, wherein the additive is an EPA 25B compliant chemical.

Aspect 21 provides the precursor solution of Aspect 20, wherein the EPA 25B compliant chemical comprises castor oil (8001-79-4), cedarwood oil (85085-29-6, 68990-83-0, 8000-27-9), cinnamon, cinnamon oil (8015-91-6), 2-hydroxypropane-1,2,3-tricarboxylic acid (77-92-9), citronella, citronella oil (8000-29-1), clove, clove oil (8000-34-8), corn gluten meal (66-071-96-3), corn oil (8001-30-7), cornmint, commint oil (68917-18-0), cottonseed oil (8001-29-4), dried blood (68911-49-9), 4-allyl-2-methoxyphenol (97-53-0), garlic, garlic oil (8000-78-0), (2e)-3,7,dimethyloctoa-2,6-dien-1-ol (106-24-1), geranium oil (8000-46-2), lauryl sulfate (151-41-7), lemongrass oil (8007-02-1), linseed oil (8001-26-1), 2-hydroxybutanedioic acid (6915-15-7), peppermint, peppermint oil (8006-90-4), 2-phenylethy propionate (122-70-3), potassium (2E,4E)-hexa-2,4-dienoate (24634-61-5), putrescent whole egg solid (51609-52-0), rosemary, rosemary oil (8000-25-7), sesame, sesame oil (8008-74-0), sodium chloride (7647-14-5), sulfuric acid monododecyl ester, sodium salt (151-21-3), soybean oil (8001-22-7), spearmint, spearmint oil (8008-79-5), thyme, thyme oil (8007-46-3), zinc (7440-66-6), or a mixture thereof.

Aspect 22 provides a plant nutrient and/or antimicrobial precursor solution comprising:
an organic amine component, comprising at least two of L-Glutamic Acid, L-Leucine, L-Isoleucine, L-Valine, L-Glutamine, L-Lysine HCL, L-Methionine, L-Phenylalanine, L-Threonine, L-Tryptophan, L-Histidine HCL, L-Proline, L-Tyrosine, Beta-Alanine, L-Arginine Base, Taurine, Glycine, L-Citrulline, Aspartic acid, Serine, Proline, Alanine, Betaine-HCL Cystine, or a mixture thereof,
a salt component comprising a mixture of a halide salt and a phosphate salt; and
an additive component comprising comprises castor oil (8001-79-4), cedarwood oil (85085-29-6, 68990-83-0, 8000-27-9), cinnamon, cinnamon oil (8015-91-6), 2-hydroxypropane-1,2,3-tricarboxylic acid (77-92-9), citronella, citronella oil (8000-29-1), clove, clove oil (8000-34-8), corn gluten meal (66-071-96-3), corn oil (8001-30-7), commint, cornmint oil (68917-18-0), cottonseed oil (8001-29-4), dried blood (68911-49-9), 4-allyl-2-methoxyphenol (97-53-0), garlic, garlic oil (8000-78-0), (2e)-3,7,dimethyloctoa-2,6-dien-1-ol (106-24-1), geranium oil (8000-46-2), lauryl sulfate (151-41-7), lemongrass oil (8007-02-1), linseed oil (8001-26-1), 2-hydroxybutanedioic acid (6915-15-7), peppermint, peppermint oil (8006-90-4), 2-phenylethy propionate (122-70-3), potassium (2E,4E)-hexa-2,4-dienoate (24634-61-5), putrescent whole egg solid (51609-52-0), rosemary, rosemary oil (8000-25-7), sesame, sesame oil (8008-74-0), sodium chloride (7647-14-5), sulfuric acid monododecyl ester, sodium salt (151-21-3), soybean oil (8001-22-7), spearmint, spearmint oil (8008-79-5), thyme, thyme oil (8007-46-3), zinc (7440-66-6), or a mixture thereof.

Aspect 23 provides the precursor solution of Aspect 22, wherein the halide salt comprises fluorine, chlorine, bromine, iodine, astatine, tennessine, or a mixture thereof.

Aspect 24 provides a plant nutrient and/or antimicrobial precursor solution comprising:
an organic amine component comprising at least one protonated organic amine.

Aspect 25 provides the precursor solution of Aspect 24, wherein the two or more organic amine component comprises at least two amino acids at least one of which his protonated.

Aspect 26 provides the precursor solution of any one of Aspects 24 or 25, wherein the organic amine component comprises L-Glutamic Acid, L-Leucine, L-Isoleucine, L-Valine, L-Glutamine, L-Lysine HCL, L-Methionine, L-Phenylalanine, L-Threonine, L-Tryptophan, L-Histidine HCL, L-Proline, L-Tyrosine, Beta-Alanine, L-Arginine Base, Taurine, Glycine, L-Citrulline, Aspartic acid, Serine, Proline, Alanine, Cystine, Betaine-HCL or a mixture thereof.

Aspect 27 provides the precursor solution of any one of Aspects 24-26, further comprising a halide salt.

Aspect 28 provides the precursor solution of Aspect 27, wherein the halide salt comprises fluorine, chlorine, bromine, iodine, astatine, tennessine, or a mixture thereof.

Aspect 29 provides the precursor solution of any one of Aspects 24-28, wherein the salt component comprises a phosphate salt.

Aspect 30 provides the precursor solution of any one of Aspects 24-29, wherein the salt component comprises a mixture of a halide salt and a phosphate salt.

Aspect 31 provides the precursor solution of any one of Aspects 24-30, further comprising an additive.

Aspect 32 provides the precursor solution of Aspect 31, wherein the additive comprises a nutritional additive, pesticide, an insect remediation chemical, or a mixture thereof.

Aspect 33 provides the precursor solution of any one of Aspects 31 or 32, wherein the additive is an EPA 25B compliant chemical.

Aspect 34 provides the precursor solution of Aspect 33, wherein the EPA 25B compliant chemical comprises castor oil (8001-79-4), cedarwood oil (85085-29-6, 68990-83-0, 8000-27-9), cinnamon, cinnamon oil (8015-91-6), 2-hydroxypropane-1,2,3-tricarboxylic acid (77-92-9), citronella, citronella oil (8000-29-1), clove, clove oil (8000-34-8), corn gluten meal (66-071-96-3), corn oil (8001-30-7), cornmint, cornmint oil (68917-18-0), cottonseed oil (8001-29-4), dried blood (68911-49-9), 4-allyl-2-methoxyphenol (97-53-0), garlic, garlic oil (8000-78-0), (2e)-3,7,dimethyloctoa-2,6-dien-1-ol (106-24-1), geranium oil (8000-46-2), lauryl sulfate (151-41-7), lemongrass oil (8007-02-1), linseed oil (8001-26-1), 2-hydroxybutanedioic acid (6915-15-7), peppermint, peppermint oil (8006-90-4), 2-phenylethy propionate (122-70-3), potassium (2E,4E)-hexa-2,4-dienoate (24634-61-5), putrescent whole egg solid (51609-52-0), rosemary, rosemary oil (8000-25-7), sesame, sesame oil (8008-74-0), sodium chloride (7647-14-5), sulfuric acid monododecyl ester, sodium salt (151-21-3), soybean oil (8001-22-7), spearmint, spearmint oil (8008-79-5), thyme, thyme oil (8007-46-3), zinc (7440-66-6), or a mixture thereof.

Aspect 35 provides a plant nutrient and/or antimicrobial precursor solution comprising:
an organic amine component comprising at least one protonated organic amine; and
a halide.

Aspect 36 provides the precursor solution of Aspect 36, wherein the two or more organic amine component comprises at least two amino acids at least one of which his protonated.

Aspect 37 provides the precursor solution of any one of Aspects 35 or 36, wherein the organic amine component comprises L-Glutamic Acid, L-Leucine, L-Isoleucine, L-Valine, L-Glutamine, L-Lysine HCL, L-Methionine, L-Phenylalanine, L-Threonine, L-Tryptophan, L-Histidine HCL, L-Proline, L-Tyrosine, Beta-Alanine, L-Arginine Base, Taurine, Glycine, L-Citrulline, Aspartic acid, Serine, Proline, Alanine, Cystine, Betaine-HCL or a mixture thereof.

Aspect 38 provides the precursor solution of any one of Aspects 36-37, wherein the halide is a counterion to the protonated organic amine.

Aspect 39 provides the precursor solution of Aspect 38, wherein the halide comprises fluorine, chlorine, bromine, iodine, astatine, tennessine, or a mixture thereof.

Aspect 40 provides the precursor solution of any one of Aspects 36-39, further comprising an additive.

Aspect 41 provides the precursor solution of Aspect 40, wherein the additive comprises a nutritional additive, pesticide, an insect remediation chemical, or a mixture thereof.

Aspect 42 provides the precursor solution of any one of Aspects 40 or 41, wherein the additive is an EPA 25B compliant chemical.

Aspect 43 provides the precursor solution of Aspect 42, wherein the EPA 25B compliant chemical comprises castor oil (8001-79-4), cedarwood oil (85085-29-6, 68990-83-0, 8000-27-9), cinnamon, cinnamon oil (8015-91-6), 2-hydroxypropane-1,2,3-tricarboxylic acid (77-92-9), citronella, citronella oil (8000-29-1), clove, clove oil (8000-34-8), corn gluten meal (66-071-96-3), corn oil (8001-30-7), cornmint, commint oil (68917-18-0), cottonseed oil (8001-29-4), dried blood (68911-49-9), 4-allyl-2-methoxyphenol (97-53-0), garlic, garlic oil (8000-78-0), (2e)-3,7,dimethyloctoa-2,6-dien-1-ol (106-24-1), geranium oil (8000-46-2), lauryl sulfate (151-41-7), lemongrass oil (8007-02-1), linseed oil (8001-26-1), 2-hydroxybutanedioic acid (6915-15-7), peppermint, peppermint oil (8006-90-4), 2-phenylethy propionate (122-70-3), potassium (2E,4E)-hexa-2,4-dienoate (24634-61-5), putrescent whole egg solid (51609-52-0), rosemary, rosemary oil (8000-25-7), sesame, sesame oil (8008-74-0), sodium chloride (7647-14-5), sulfuric acid monododecyl ester, sodium salt (151-21-3), soybean oil (8001-22-7), spearmint, spearmint oil (8008-79-5), thyme, thyme oil (8007-46-3), zinc (7440-66-6), or a mixture thereof.

Aspect 44 provides an activated plant nutrient and/or antimicrobial solution of any one of Aspects 1-43.

Aspect 45 provides a method of making the activated plant nutrient and/or antimicrobial solution of Aspect 44, the method comprising:
applying an electrical voltage to the plant nutrient and/or antimicrobial precursor solution disposed in a reaction vessel; and
producing the activated organic amine component.

Aspect 46 provides the method of Aspect 45, wherein the voltage is in a range of from about 4V to about 10V.

Aspect 47 provides the method of any one of Aspects 45 or 46, further comprising combining the additive with the organic amine component and salt component prior to applying the electrical voltage.

Aspect 48 provides a method of using the plant nutrient and/or antimicrobial solution of any one of Aspects 1-47, the method comprising applying the solution to a plant.

What is claimed is:

1. A plant nutrient and/or antimicrobial precursor solution comprising:
an organic amine component comprising two or more organic amines; and
a salt component.

2. The precursor solution of claim 1, wherein the two or more organic amines comprises two amino acids.

3. The precursor solution of any one of claim 1 or 2, wherein the organic amine component comprises L-Glutamic Acid, L-Leucine, L-Isoleucine, L-Valine, L-Glutamine, L-Lysine HCL, L-Methionine, L-Phenylalanine, L-Threonine, L-Tryptophan, L-Histidine HCL, L-Proline, L-Tyrosine, Beta-Alanine, L-Arginine Base, Taurine, Glycine, L-Citrulline, Aspartic acid, Serine, Proline, Alanine, Cystine, Betaine-HCL or a mixture thereof.

4. The precursor solution of any one of claims 1-3, wherein the salt component comprises a halide salt.

5. The precursor solution of claim 4, wherein the halide salt comprises fluorine, chlorine, bromine, iodine, astatine, tennessine, or a mixture thereof.

6. The precursor solution of any one of claims 1-5, wherein the salt component comprises a phosphate salt.

7. The precursor solution of any one of claims 1-6, wherein the salt component comprises a mixture of a halide salt and a phosphate salt.

8. The precursor solution of any one of claims 1-7, further comprising an additive.

9. The precursor solution of claim 8, wherein the additive comprises a nutritional additive, pesticide, an insect remediation chemical, or a mixture thereof.

10. The precursor solution of any one of claim 8 or 9, wherein the additive is an EPA 25B compliant chemical.

11. The precursor solution of claim 10, wherein the EPA 25B compliant chemical comprises castor oil (8001-79-4), cedarwood oil (85085-29-6, 68990-83-0, 8000-27-9), cinnamon, cinnamon oil (8015-91-6), 2-hydroxypropane-1,2,3-tricarboxylic acid (77-92-9), citronella, citronella oil (8000-29-1), clove, clove oil (8000-34-8), corn gluten meal (66-071-96-3), corn oil (8001-30-7), commint, cornmint oil (68917-18-0), cottonseed oil (8001-29-4), dried blood (68911-49-9), 4-allyl-2-methoxyphenol (97-53-0), garlic, garlic oil (8000-78-0), (2e)-3,7,dimethyloctoa-2,6-dien-1-ol (106-24-1), geranium oil (8000-46-2), lauryl sulfate (151-41-7), lemongrass oil (8007-02-1), linseed oil (8001-26-1), 2-hydroxybutanedioic acid (6915-15-7), peppermint, peppermint oil (8006-90-4), 2-phenylethy propionate (122-70-3), potassium (2E,4E)-hexa-2,4-dienoate (24634-61-5), putrescent whole egg solid (51609-52-0), rosemary, rosemary oil (8000-25-7), sesame, sesame oil (8008-74-0), sodium chloride (7647-14-5), sulfuric acid monododecyl ester, sodium salt (151-21-3), soybean oil (8001-22-7), spearmint, spearmint oil (8008-79-5), thyme, thyme oil (8007-46-3), zinc (7440-66-6), or a mixture thereof.

12. A plant nutrient and/or antimicrobial precursor solution comprising:
an organic amine component comprising two or more amino acids;
a salt component; and
an additive component.

13. The precursor solution of claim 12, wherein the organic amine component comprises two amino acids.

14. The precursor solution of any one of claim 12 or 13, wherein the organic amine component comprises L-Glutamic Acid, L-Leucine, L-Isoleucine, L-Valine, L-Glutamine, L-Lysine HCL, L-Methionine, L-Phenylalanine, L-Threonine, L-Tryptophan, L-Histidine HCL, L-Proline, L-Tyrosine, Beta-Alanine, L-Arginine Base, Taurine, Glycine, L-Citrulline, Aspartic acid, Serine, Proline, Alanine, Cystine, Betaine-HCL or a mixture thereof.

15. The precursor solution of any one of claims 12-14, wherein the salt component comprises a halide salt.

16. The precursor solution of claim 15, wherein the halide salt comprises fluorine, chlorine, bromine, iodine, astatine, tennessine, or a mixture thereof.

17. The precursor solution of any one of claims 12-16, wherein the salt component comprises a phosphate salt.

18. The precursor solution of any one of claims 12-17, wherein the salt component comprises a mixture of a halide salt and a phosphate salt.

19. The precursor solution of any one of claims 12-18, wherein the additive comprises a nutritional additive, pesticide, an insect remediation chemical, or a mixture thereof.

20. The precursor solution of claim 19, wherein the additive is an EPA 25B compliant chemical.

21. The precursor solution of claim 20, wherein the EPA 25B compliant chemical comprises castor oil (8001-79-4), cedarwood oil (85085-29-6, 68990-83-0, 8000-27-9), cinnamon, cinnamon oil (8015-91-6), 2-hydroxypropane-1,2,3-tricarboxylic acid (77-92-9), citronella, citronella oil (8000-29-1), clove, clove oil (8000-34-8), corn gluten meal (66-071-96-3), corn oil (8001-30-7), cornmint, cornmint oil (68917-18-0), cottonseed oil (8001-29-4), dried blood (68911-49-9), 4-allyl-2-methoxyphenol (97-53-0), garlic, garlic oil (8000-78-0), (2e)-3,7,dimethyloctoa-2,6-dien-1-ol (106-24-1), geranium oil (8000-46-2), lauryl sulfate (151-41-7), lemongrass oil (8007-02-1), linseed oil (8001-26-1), 2-hydroxybutanedioic acid (6915-15-7), peppermint, peppermint oil (8006-90-4), 2-phenylethy propionate (122-70-3), potassium (2E,4E)-hexa-2,4-dienoate (24634-61-5), putrescent whole egg solid (51609-52-0), rosemary, rosemary oil (8000-25-7), sesame, sesame oil (8008-74-0), sodium chloride (7647-14-5), sulfuric acid monododecyl ester, sodium salt (151-21-3), soybean oil (8001-22-7), spearmint, spearmint oil (8008-79-5), thyme, thyme oil (8007-46-3), zinc (7440-66-6), or a mixture thereof.

22. A plant nutrient and/or antimicrobial precursor solution comprising:
an organic amine component, comprising at least two of L-Glutamic Acid, L-Leucine, L-Isoleucine, L-Valine, L-Glutamine, L-Lysine HCL, L-Methionine, L-Phenylalanine, L-Threonine, L-Tryptophan, L-Histidine HCL, L-Proline, L-Tyrosine, Beta-Alanine, L-Arginine Base, Taurine, Glycine, L-Citrulline, Aspartic acid, Serine, Proline, Alanine, Betaine-HCL Cystine, or a mixture thereof,
a salt component comprising a mixture of a halide salt and a phosphate salt; and
an additive component comprising comprises castor oil (8001-79-4), cedarwood oil (85085-29-6, 68990-83-0, 8000-27-9), cinnamon, cinnamon oil (8015-91-6), 2-hydroxypropane-1,2,3-tricarboxylic acid (77-92-9), citronella, citronella oil (8000-29-1), clove, clove oil (8000-34-8), corn gluten meal (66-071-96-3), corn oil (8001-30-7), commint, cornmint oil (68917-18-0), cottonseed oil (8001-29-4), dried blood (68911-49-9), 4-allyl-2-methoxyphenol (97-53-0), garlic, garlic oil (8000-78-0), (2e)-3,7, dimethyloctoa-2,6-dien-1-ol (106-24-1), geranium oil (8000-46-2), lauryl sulfate (151-41-7), lemongrass oil (8007-02-1), linseed oil (8001-26-1), 2-hydroxybutanedioic acid (6915-15-7), peppermint, peppermint oil (8006-90-4), 2-phenylethy propionate (122-70-3), potassium (2E,4E)-hexa-2,4-dienoate (24634-61-5), putrescent whole egg solid (51609-52-0), rosemary, rosemary oil (8000-25-7), sesame, sesame oil (8008-74-0), sodium chloride (7647-14-5), sulfuric acid monododecyl ester, sodium salt (151-21-3), soybean oil (8001-22-7), spearmint, spearmint oil (8008-79-5), thyme, thyme oil (8007-46-3), zinc (7440-66-6), or a mixture thereof.

23. The precursor solution of claim 22, wherein the halide salt comprises fluorine, chlorine, bromine, iodine, astatine, tennessine, or a mixture thereof.

24. A plant nutrient and/or antimicrobial precursor solution comprising:
an organic amine component comprising at least one protonated organic amine.

25. The precursor solution of claim 24, wherein the two or more organic amine component comprises at least two amino acids at least one of which his protonated.

26. The precursor solution of any one of claim 24 or 25, wherein the organic amine component comprises L-Glutamic Acid, L-Leucine, L-Isoleucine, L-Valine, L-Glutamine, L-Lysine HCL, L-Methionine, L-Phenylalanine, L-Threonine, L-Tryptophan, L-Histidine HCL, L-Proline, L-Tyrosine, Beta-Alanine, L-Arginine Base, Taurine, Glycine, L-Citrulline, Aspartic acid, Serine, Proline, Alanine, Cystine, Betaine-HCL or a mixture thereof.

27. The precursor solution of any one of claims 24-26, further comprising a halide salt.

28. The precursor solution of claim 27, wherein the halide salt comprises fluorine, chlorine, bromine, iodine, astatine, tennessine, or a mixture thereof.

29. The precursor solution of any one of claims 24-28, wherein the salt component comprises a phosphate salt.

30. The precursor solution of any one of claims 24-29, wherein the salt component comprises a mixture of a halide salt and a phosphate salt.

31. The precursor solution of any one of claims 24-30, further comprising an additive.

32. The precursor solution of claim 31, wherein the additive comprises a nutritional additive, pesticide, an insect remediation chemical, or a mixture thereof.

33. The precursor solution of any one of claim 31 or 32, wherein the additive is an EPA 25B compliant chemical.

34. The precursor solution of claim 33, wherein the EPA 25B compliant chemical comprises castor oil (8001-79-4), cedarwood oil (85085-29-6, 68990-83-0, 8000-27-9), cinnamon, cinnamon oil (8015-91-6), 2-hydroxypropane-1,2,3-tricarboxylic acid (77-92-9), citronella, citronella oil (8000-29-1), clove, clove oil (8000-34-8), corn gluten meal (66-071-96-3), corn oil (8001-30-7), commint, cornmint oil (68917-18-0), cottonseed oil (8001-29-4), dried blood (68911-49-9), 4-allyl-2-methoxyphenol (97-53-0), garlic, garlic oil (8000-78-0), (2e)-3,7,dimethyloctoa-2,6-dien-1-ol (106-24-1), geranium oil (8000-46-2), lauryl sulfate (151-41-7), lemongrass oil (8007-02-1), linseed oil (8001-26-1), 2-hydroxybutanedioic acid (6915-15-7), peppermint, peppermint oil (8006-90-4), 2-phenylethy propionate (122-70-3), potassium (2E,4E)-hexa-2,4-dienoate (24634-61-5), putrescent whole egg solid (51609-52-0), rosemary, rosemary oil (8000-25-7), sesame, sesame oil (8008-74-0), sodium chloride (7647-14-5), sulfuric acid monododecyl ester, sodium salt (151-21-3), soybean oil (8001-22-7), spearmint, spearmint oil (8008-79-5), thyme, thyme oil (8007-46-3), zinc (7440-66-6), or a mixture thereof.

35. A plant nutrient and/or antimicrobial precursor solution comprising:
an organic amine component comprising at least one protonated organic amine; and
a halide.

36. The precursor solution of claim 36, wherein the two or more organic amine component comprises at least two amino acids at least one of which his protonated.

37. The precursor solution of any one of claim 35 or 36, wherein the organic amine component comprises L-Glutamic Acid, L-Leucine, L-Isoleucine, L-Valine, L-Glutamine, L-Lysine HCL, L-Methionine, L-Phenylalanine, L-Threonine, L-Tryptophan, L-Histidine HCL, L-Proline, L-Tyrosine, Beta-Alanine, L-Arginine Base, Taurine, Glycine, L-Citrulline, Aspartic acid, Serine, Proline, Alanine, Cystine, Betaine-HCL or a mixture thereof.

38. The precursor solution of any one of claims 36-37, wherein the halide is a counterion to the protonated organic amine.

39. The precursor solution of claim 38, wherein the halide comprises fluorine, chlorine, bromine, iodine, astatine, tennessine, or a mixture thereof.

40. The precursor solution of any one of claims 36-39, further comprising an additive.

41. The precursor solution of claim 40, wherein the additive comprises a nutritional additive, pesticide, an insect remediation chemical, or a mixture thereof.

42. The precursor solution of any one of claim 40 or 41, wherein the additive is an EPA 25B compliant chemical.

43. The precursor solution of claim 42, wherein the EPA 25B compliant chemical comprises castor oil (8001-79-4), cedarwood oil (85085-29-6, 68990-83-0, 8000-27-9), cinnamon, cinnamon oil (8015-91-6), 2-hydroxypropane-1,2,3-tricarboxylic acid (77-92-9), citronella, citronella oil (8000-29-1), clove, clove oil (8000-34-8), corn gluten meal (66-071-96-3), corn oil (8001-30-7), commint, cornmint oil (68917-18-0), cottonseed oil (8001-29-4), dried blood (68911-49-9), 4-allyl-2-methoxyphenol (97-53-0), garlic, garlic oil (8000-78-0), (2e)-3,7,dimethyloctoa-2,6-dien-1-ol (106-24-1), geranium oil (8000-46-2), lauryl sulfate (151-41-7), lemongrass oil (8007-02-1), linseed oil (8001-26-1), 2-hydroxybutanedioic acid (6915-15-7), peppermint, peppermint oil (8006-90-4), 2-phenylethy propionate (122-70-3), potassium (2E,4E)-hexa-2,4-dienoate (24634-61-5), putrescent whole egg solid (51609-52-0), rosemary, rosemary oil (8000-25-7), sesame, sesame oil (8008-74-0), sodium chloride (7647-14-5), sulfuric acid monododecyl ester, sodium salt (151-21-3), soybean oil (8001-22-7), spearmint, spearmint oil (8008-79-5), thyme, thyme oil (8007-46-3), zinc (7440-66-6), or a mixture thereof.

44. An activated plant nutrient and/or antimicrobial solution of any one of claims 1-43.

45. A method of making the activated plant nutrient and/or antimicrobial solution of claim 44, the method comprising:
applying an electrical voltage to the plant nutrient and/or antimicrobial precursor solution disposed in a reaction vessel; and
producing the activated organic amine component.

46. The method of claim 45, wherein the voltage is in a range of from about 4V to about 10V.

47. The method of any one of claim 45 or 46, further comprising combining the additive with the organic amine component and salt component prior to applying the electrical voltage.

48. A method of using the plant nutrient and/or antimicrobial solution of any one of claims 1-47, the method comprising applying the solution to a plant.
